(19) United States
(12) Patent Application Publication
(10) Pub. No.: US 2026/0106538 A1
(43) Pub. Date: Apr. 16, 2026

(54) SOFT-START METHOD, DEVICE, AND SYSTEM OF HDT BASED ON UNBYPASSING ITS VOLTAGE-COMPENSATING CONVERTER

(71) Applicant: XI'AN JIAOTONG UNIVERSITY, Xi'an (CN)

(72) Inventors: Yibin LIU, Xi'an (CN); Deliang LIANG, Xi'an (CN); Yanting XUE, Xi'an (CN); Hao JIN, Xi'an (CN)

(73) Assignee: XI'AN JIAOTONG UNIVERSITY, Xi'an (CN)

(21) Appl. No.: 19/379,875

(22) Filed: Nov. 5, 2025

Related U.S. Application Data
(63) Continuation of application No. PCT/CN2024/119109, filed on Sep. 14, 2024.

(30) Foreign Application Priority Data
Aug. 6, 2024 (CN) 2024110729026

(51) Int. Cl. H02M 1/36; H02M 1/00; H02M 5/45; H02M 5/451

(52) U.S. Cl. CPC H02M 1/36; H02M 1/0009; H02M 1/0019; H02M 5/4505; H02M 5/451

(57) ABSTRACT

Disclosed are a soft start method, device, and system of a hybrid distribution transformer (HDT) based on unbypassing its voltage-compensating converter, which belong to the technical field of transformer control. According to the method, through a grid-side current controller, a DC-link voltage controller, a split-capacitor voltage balance controller, and a load voltage controller, a start process of the HDT is divided into an uncontrolled rectification stage and a PWM rectification stage. According to the present disclosure, an anti-parallel thyristor of the voltage-compensating converter is closed without a bypass in a process of energization. A DC-link capacitor is charged by respective converters of two transformers of the HDT simultaneously, and thus an energization flow is simpler. In addition, an inrush current at an initial phase of the PWM rectification stage can be effectively mitigated by improving an existing steady-state control strategy.

### CROSS-REFERENCE TO RELATED APPLICATIONS

The application claims priority to Chinese patent application No. 2024110729026, filed on Aug. 6, 2024, the entire contents of which are incorporated herein by reference.

### TECHNICAL FIELD

The present disclosure belongs to the field of transformers, and in particular to a soft-start method, device, and system of a hybrid distribution transformer (HDT) based on unbypassing its voltage-compensating converter.

### BACKGROUND

The hybrid distribution transformer (HDT), a type of novel controlled distribution transformer, is prominently characterized in that a voltage-compensating converter and a current-compensating converter are connected into a traditional distribution transformer and share the common DC-link capacitors. Compared with the traditional distribution transformer, the HDT can mitigate the adverse effects of load currents-such as harmonics, reactive power, and asymmetry-on the distribution grid, with the aid of the current-compensating converter. Moreover, via the voltage-compensating converter, the HDT can mitigate the adverse effects of grid-side voltage fluctuations and asymmetry on the load power supply.

During construction practice, soft-start is inevitable for grid-connected operation of the HDT. In a traditional HDT soft-start strategy, a bypass of the voltage-compensating converter is required to be pre-closed through an anti-parallel thyristor. The DC-link capacitor is naturally charged through the current-compensating converter separately in an uncontrolled rectification mode. After a link voltage rises to a rated value, the anti-parallel thyristor is opened. Then, closed-loop control over the voltage-compensating converter of the HDT is started at the moment when a current of the thyristor crosses zero.

However, the above start strategy is obviously defective during practical application in the distribution grid. Specifically, before the HDT is connected to the grid, a system has no power as a whole, a control circuit cannot send out a control signal, and the anti-parallel thyristor cannot be closed. To control the anti-parallel thyristor to be closed, an additional auxiliary power supply is required. Thus, the overall investment of the system and the complexity of the start strategy will be increased.

### SUMMARY

An objective of the present disclosure is to overcome the above defects in the prior art, and provides a soft-start method, device, and system of a hybrid distribution transformer (HDT) based on unbypassing its voltage-compensating converter, to solve the growing complexity of a start strategy because during start of an HDT in the prior art, an additional auxiliary power supply is required to control an anti-parallel thyristor to be close.

To achieve the above objective, the present disclosure employs the technical solution as follows:

A soft-start method of an HDT based on unbypassing its voltage-compensating converter is provided. The method includes an uncontrolled rectification stage and a PWM rectification stage; where
the uncontrolled rectification stage includes:
S101, opening an anti-parallel thyristor on a voltage-compensating converter bypass and a contactor on a bypass of a DC-link damping resistor, and closing a circuit breaker of the HDT;
S102, energizing a power supply module of a control circuit and a detection circuit of the HDT in a case where a DC-link voltage exceeds a threshold; and
S103, closing the contactor on the bypass of the DC-link damping resistor after set delay time in a case where the control circuit of the HDT is stabilized; and
the PWM rectification stage includes:
S201, starting a current-compensating converter, and performing closed-loop control; and
S202, starting the voltage-compensating converter after the current-compensating converter is started and a DC-link voltage rises beyond an uncontrolled rectification steady-state value.

The present disclosure is further improved as follows:

Preferably, in S101, an isolation transformer maintains a fixed voltage ratio with a main transformer, and the voltage-compensating converter and a current-compensating converter charge a DC-link capacitor simultaneously.

Preferably, in S103, the detection circuit sends out a contactor closing signal after the set delay time, and the contactor on the bypass of the DC-link damping resistor is closed.

A soft-start device of an HDT based on unbypassing its voltage-compensating converter is further provided. The device is configured to implement the above soft-start method based on unbypassing and includes:
a grid-side current controller configured to control a current-compensating converter; cause each insulated gate bipolar transistor (IGBT) in the current-compensating converter to be in a locked state before closed-loop control over the current-compensating converter; and acquire a drive pulse signal of each IGBT after the current-compensating converter is enabled;
a DC-link voltage controller configured to acquire a deviation by comparing a real-time value and a reference value of a DC-link voltage; perform an operation on the deviation through a proportional-integral (PI) controller, a low-pass filter, and a trap; and acquire a reference instruction of a grid-side current inner loop;
a split-capacitor voltage balance controller configured to acquire a difference by comparing voltages of two DC-link capacitors; take the difference as a zero-axis reference signal of a load in a case where the current-compensating converter is not enabled; and take the difference subjected to integral separation as a zero-axis reference signal of a load in a case where the current-compensating converter is enabled; and
a load voltage controller configured to control the voltage-compensating converter; cause each IGBT in the voltage-compensating converter to be in a locked state before closed-loop control; and acquire a drive pulse signal of each IGBT after the voltage-compensating converter is enabled.

Preferably, a small amplitude limitation threshold is applied to the DC-link voltage controller in a case where the DC-link voltage does not exceed a rated value; and a normal amplitude limitation threshold corresponding to a grid-side rated current is applied to the DC-link voltage controller in a case where the DC-link voltage exceeds a rated value; where
the small amplitude limitation threshold is 20%-30% of the grid-side rated current.

Preferably, a PI parameter of the grid-side current controller, a PI parameter of the DC-link voltage controller, a PI parameter of the split-capacitor voltage balance controller, and a PI parameter of the load voltage controller are regulated through corresponding dynamic gain coefficients.

Preferably, the DC-link voltage controller, the split-capacitor voltage balance controller, and the grid-side current controller are started simultaneously in a case where the closed-loop control over a current-compensating converter is started; and a variable parameter link and an integral separation link are set in a PI controller of the DC-link voltage controller.

Preferably, in the grid-side current controller, i_{Psd}, i_{Psq}, and i_{Ps0} are acquired through real-time i_{Psk} in a case where the current-compensating converter is enabled; and modulation signals m_{pd}, m_{pq}, and mₚ₀ are generated through an i_{Psk} variable PI controller, and each drive pulse signal is acquired through sinusoidal pulse width modulation (SPWM); and
in the load voltage controller, u_{2d}, u_{2q}, and u₂₀ are acquired through real-time u₂ₖ in a case where the voltage-compensating converter is enabled; and modulation signals m_{td}, m_{tq}, and mₜ₀ are generated through a u₂ₖ variable PI controller, and each drive pulse signal is acquired through SPWM.

Preferably, a variable parameter link and an integral separation link are set in each of the i_{Psk} variable PI controller of the grid-side current controller and the u₂ₖ variable PI controller of the load voltage controller.

A soft-start system based on unbypassing a voltage-compensating converter is further provided. The system is configured to implement the above soft-start method based on unbypassing and includes a main transformer, an isolation transformer, a current-compensating converter, and a voltage-compensating converter; where the main transformer is connected to the isolation transformer in series;
a primary side of the main transformer is in delta connection to a grid through a circuit breaker, and a secondary side of the main transformer is in star connection to a load through a circuit breaker;
the current-compensating converter is connected to an auxiliary winding of the main transformer in parallel, and the voltage-compensating converter is connected to a primary winding in series through the isolation transformer; and
the current-compensating converter and the voltage-compensating converter share the DC-link capacitors, the DC-link capacitor includes two capacitors connected in series, each capacitor is connected to one damping resistor, each damping resistor is provided with one bypass, and each bypass is provided with one bypass contactor.

Compared with the prior art, the present disclosure has the beneficial effects as follows:

The soft-start method, device, and system of an HDT based on unbypassing its voltage-compensating converter are disclosed in the present disclosure. The present disclosure is a type of soft-start technology of the HDT based on unbypassing its voltage-compensating converter, which realizes short-delay application of the voltage-compensating converter and variable parameter control. Thus, the HDT can be started and connected to the grid for operation safely and smoothly. According to the present disclosure, the anti-parallel thyristor of the voltage-compensating converter is closed without the bypass in a process of energization. The DC-link capacitor is charged by respective converters of two transformers of the HDT simultaneously, and thus an energization flow is simpler. In addition, an inrush current at an initial phase of the PWM rectification stage can be effectively mitigated by improving an existing steady-state control strategy. According to the start method, the anti-parallel thyristor of the voltage-compensating converter is closed without the bypass. The method also has the following advantages:

1) Simple flow: compared with a traditional start strategy, according to the present start strategy, none of closing control over the anti-parallel thyristor on the bypass, opening the bypass contactor after the soft-start is completed, and controlling the voltage-compensating converter to be started on time at a zero-crossing point is required in an entire process, so that the process is simpler and more reliable.

2) High economic efficiency: compared with the traditional start strategy, no additional auxiliary power supply is required to specially control the bypass of the anti-parallel thyristor to be closed.

3) High safety and reliability: the inrush current caused by various factors can be effectively avoided through the short-delay start of the voltage-compensating converter, the variable parameter control, and condition amplitude limitation, so that safety and reliability of the process of energization can be ensured.

### BRIEF DESCRIPTION OF DRAWINGS

FIG. 1 shows a main circuit topology of a hybrid distribution transformer (HDT) involved in the present disclosure;

FIG. 2 shows a detailed process of a soft-start strategy involved in the present disclosure;

FIG. 3 is a block diagram of improved DC-link voltage control;

FIG. 4 is a block diagram of split-capacitor voltage balance control;

FIG. 5 is a block diagram of improved grid-side current control; and

FIG. 6 is a block diagram of improved load voltage control.

### DETAILED DESCRIPTION OF THE EMBODIMENTS

The present disclosure will be further described in detail below with reference to the accompanying drawings.

In the description of the present disclosure, it should be noted that the orientation or position relations indicated by the terms “central”, “upper”, “lower”, “left”, “right”, “vertical”, “horizontal”, “inner”, “outer”, etc. are based on the orientation or position relations shown in the accompanying drawings, are merely for facilitating the description of the present disclosure and simplifying the description, rather than indicating or implying that the device or element referred to must have a particular orientation or be constructed and operated in a particular orientation, and thus cannot be interpreted as limiting the present disclosure. The terms “first”, “second”, and “third” are merely used for description, and cannot be interpreted as indicating or implying the relative importance. In addition, the terms “mount”, “connect”, and “connection” should be understood broadly, unless expressly specified and limited otherwise. For example, they can denote fixed connection, detachable connection, direct connection, indirect connection through an intermediate medium, or internal communication between two elements. For those of ordinary skill in the art, the specific meanings of the above terms in the present disclosure can be understood according to specific circumstances.

A soft-start system of a hybrid distribution transformer based on unbypassing its voltage-compensating converter is disclosed in a first aspect of the present disclosure. A three-phase hybrid distribution transformer (HDT) serves as a main circuit for a soft-start method of a hybrid distribution transformer based on unbypassing its voltage-compensating converter. The three-phase HDT includes a main transformer (including a primary winding, a secondary winding, and an auxiliary winding), an isolation transformer (including a grid-side winding and a valve-side winding), a voltage-compensating converter, and a current-compensating converter.

The current-compensating converter is connected to the auxiliary winding in parallel, to implement grid-side current regulation and control. The voltage-compensating converter and the primary winding are connected in series through the isolation transformer, and connected into a 10 kV medium-voltage side, to implement load voltage stability control. The two converters share a DC-link capacitor, the link capacitor is connected to a damping resistor in series, the damping resistor is provided with a bypass contactor, and a circuit breaker is mounted at the 10 kV side. Hardware of a control system includes a control circuit, an insulated gate bipolar transistor (IGBT) drive circuit, and a detection circuit. The control circuit mainly receives collection signals from the detection circuit, and sends out level signals to control on-off of a switch according to a soft-start strategy.

A soft-start device of an HDT based on unbypassing its voltage-compensating converter is disclosed in a second aspect of the present disclosure. The device is configured to implement the soft-start method of an HDT based on unbypassing its voltage-compensating converter, and further includes an improved grid-side current controller, an improved DC-link voltage controller, an improved split-capacitor voltage balance controller, and an improved load voltage controller. A d-axis reference signal of a grid-side current proportional-integral (PI) control system serves as output of the DC-link voltage controller. A zero-axis reference signal of the grid-side current PI control system serves as output of the split-capacitor voltage balance controller. A rated voltage of the DC-link voltage controller serves as a reference signal of the DC-link voltage controller. A rated load peak voltage serves as a d-axis reference signal of the load voltage controller.

Based on the above device, a soft-start method of an HDT based on unbypassing its voltage-compensating converter is disclosed in the present disclosure. The method includes an uncontrolled rectification stage and a PWM rectification stage.

The uncontrolled rectification stage includes:
S101, the HDT maintains unloaded, an anti-parallel thyristor on a bypass of the voltage-compensating converter is in an opened state, and a contactor on a bypass of a direct-current side damping resistor maintains an opened state. A grid-side circuit breaker of the HDT is closed on this premise. Then, an isolation transformer maintains a fixed voltage ratio with a main transformer, and a DC-link capacitor is charged simultaneously through the voltage-compensating converter and a current-compensating converter. Under the action of the damping resistor, an inrush current generated during start at an initial phase of the uncontrolled rectification stage is limited.
S102, a power supply module of a control system of the HDT enters a normal working state in a case where a DC-link voltage exceeds a threshold; and then, a control circuit and a detection circuit work normally, and an IGBT drive circuit and the contactor are closed or opened by generating, by the control circuit, a level signal.
S103, a control chip of a control circuit of the HDT enters an interruption and waiting state, a control chip of the detection circuit enters an interruption and waiting state, and a contactor closing signal is sent out after set delay time, to bypass the DC-link damping resistor and enter a final phase of the uncontrolled rectification stage.

The PWM rectification stage includes:
S201, closed-loop control over the current-compensating converter is started. Specifically, the DC-link voltage controller, the split-capacitor voltage balance controller, and the grid-side current closed-loop controller are started simultaneously. The DC-link voltage controller employs an integral separation strategy. To be specific, an initial value of an integral coefficient maintains zero, and the integral coefficient is restored to a normal value after a DC-link voltage rises to a rated value. Thus, a situation that overshoot is caused by a huge difference between a reference value and an actual value of the DC-link voltage at an initial phase of energization while a load voltage control system has not started to operate yet is avoided.
S202, the voltage-compensating converter is not started immediately after the current-compensating converter is started, and the voltage-compensating converter is started after the DC-link voltage rises appropriately and exceeds an uncontrolled rectification steady-state value to a particular extent. Thus, a terminal voltage is not changed suddenly at the moment of a switch from uncontrolled rectification to PWM rectification. At an initial phase of the PWM rectification, the DC-link voltage and a control capacity of the current-compensating converter are dramatically low, and thus the inrush current caused by a sudden change of the terminal voltage cannot be suppressed. However, after the voltage-compensating converter applied after a short delay is configured, the DC-link voltage rises, and an anti-interference capacity is improved, so that such an inrush current can be effectively suppressed.

At the PWM rectification stage, an existing closed-loop control system of the HDT is further required to be improved, otherwise the inrush current is still caused at the initial phase of the PWM rectification. Improvement 1, the output condition amplitude limitation of the DC-link voltage controller is added. Specifically, a small amplitude limitation threshold is applied to the controller before the DC-link voltage exceeds a rated value, where the amplitude limitation threshold is 20%-30% of a grid-side rated current. In a case where the DC-link voltage exceeds the rated value for the first time and enters a steady state, a normal amplitude limitation threshold corresponding to the grid-side rated current is applied after the soft-start is ended. Thus, a reference value of the grid-side current generated during the soft-start is directly decreased, and a charging current is decreased accordingly. Improvement 2, PI parameters of all four controllers except for a deviation suppression system are multiplied by corresponding dynamic gain coefficients. The dynamic coefficient of each controller may be changed as required in real time based on the DC-link voltage, to overcome the influence caused by a change of the DC-link voltage. It is crucial that at the initial phase of the PWM rectification, a dynamic coefficient of a grid-side current controller may provide a great open-loop gain for the current-compensating converter in a case where the link voltage is dramatically low. Thus, a reference instruction can be rapidly tracked, and the inrush current can be obviously decreased.

It should be noted that short ineffective waiting time exists between the uncontrolled rectification stage and the PWM rectification stage, which is a time gap for the switch between the two stages.

The present disclosure is further described below with reference to a specific example.

### Example

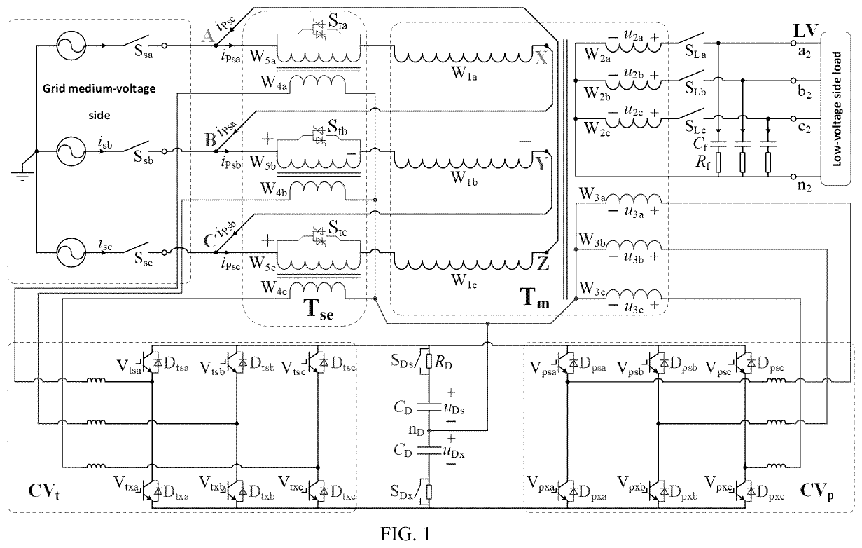

A soft-start system of an HDT based on unbypassing its voltage-compensating converter is disclosed in the example. As shown in FIG. 1, a main circuit topology of the HDT involved consists of four parts: Tₘ (a main transformer), Tₛₑ (an isolation transformer), CVₚ (a current-compensating converter), and CVₜ (a voltage-compensating converter).

The main transformer Tₘ includes a primary winding W₁ₖ, a secondary winding W₂ₖ, and an auxiliary winding W₃ₖ, where k denotes a phase sequence that is indicated by a, b, or c in the present disclosure. The isolation transformer Tₛₑ includes a valve-side winding W₄ₖ and a grid-side winding W₅ₖ. The main transformer Tₘ is connected to the isolation transformer Tₛₑ in series.

A medium-voltage (MV) side of the HDT is in delta connection to a grid through a circuit breaker Sₛₖ. A low-voltage (LV) side of the HDT supplies power to a load in a star connection manner through a circuit breaker S_{Lk}.

The current-compensating converter CVₚ is connected to the auxiliary winding W₃ₖ in parallel, to implement grid-side current regulation and control. The voltage-compensating converter CVₜ and the primary winding are connected in series through the isolation transformer Tₛₑ, and connected into a 10 kV medium-voltage side, to implement load voltage stability control. The current-compensating converter CVₚ and the voltage-compensating converter CVₜ share a DC-link capacitor C_{D}, the link capacitor is connected to a damping resistor R_{D} in series, the damping resistor is provided with a bypass contactor, and the circuit breaker is mounted at the 10 kV side. S_{Ds} and S_{Dx} denote bypass contactors configured to support soft-start of the HDT. Sₜₖ denotes an anti-parallel silicon controlled rectifier on a bypass of the voltage-compensating converter CVₜ.

A common DC-link is provided with two DC-link capacitors C_{D} connected in series. One damping resistor R_{D} is arranged at each of two sides of the two DC-link capacitors C_{D}. Each damping resistor R_{D} is provided with one bypass, and two bypasses are provided with the bypass contactor S_{Ds} and the bypass contactor S_{Dx} respectively.

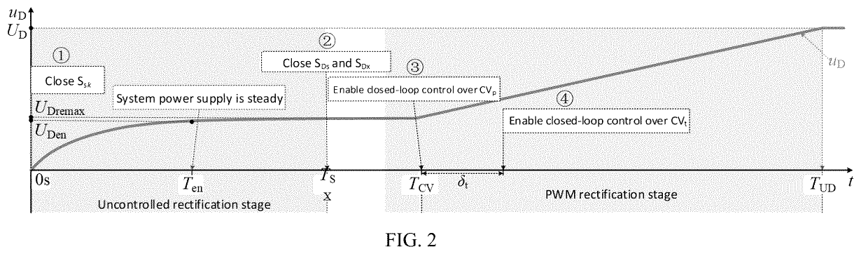

A process of soft-start of the HDT based on unbypassing its voltage-compensating converter may be divided into two stages, i.e. an uncontrolled rectification stage and a PWM rectification stage, according to a time process. A detailed process is shown in FIG. 2.

The uncontrolled rectification stage involved starts at the time of closing Sₛₖ (t=0 s), and ends at the time of closing S_{Ds} and S_{Dx} (t=T_{SX}). In such a stage, the HDT charges its DC-link capacitor through anti-parallel diodes (Dₜₛₖ, Dₜₓₖ, Dₚₛₖ, and Dₚₓₖ) in the isolation transformer and the main transformer, which belongs to natural charging and cannot be actively controlled. Thus, such a stage is referred to as the uncontrolled rectification stage. To limit an inrush current at an initial phase of energization, the bypass contactors S_{Ds} and S_{Dx} of R_{D} are initially in an opened state, so that the DC-link capacitor is charged through the R_{D}. Assuming that at (=Tₑₙ, u_{D} reaches a lowest level of an input voltage required by a system switching power supply, hardware circuits of a control system may operate stably. Next, a control chip sends out a closing instruction after a corresponding delay according to set delay time of a timer. Finally, after a mechanical delay of the contactor, at t=Tₛₓ, S_{Ds} and S_{Dx} are closed, and R_{D} is bypassed, so that the uncontrolled rectification stage ends. A steady-state value of u_{D}, recorded as U_{Dremax}, may be calculated according to a formula as follows:

$${U}_{Dremax} = 2 \sqrt{2} {U}_{s} / ( {K}_{54} + {K}_{13} ) \qquad ( 1 )$$

In the formula, Uₛ denotes an effective value of a grid-side voltage, K₅₄ denotes a turns ratio of the grid-side winding to the valve-side winding of the isolation transformer, and K₁₃ denotes a turns ratio of the primary winding to the auxiliary winding of the main transformer.

The PWM rectification stage involved starts at the time (t=T_{CV}) of enabling closed-loop control of CVₚ, and ends at the time (=T_{UD}) when u_{D} (u_{D}=u_{Ds}+u_{Dx}) reaches its rated value U_{D}. Specifically, first, at t=T_{CV}, the closed-loop control over CVₚ is enabled. The DC-link capacitor of the HDT is continuously energized through tracking control, by the CVₚ, over an active current instruction. After a particular delay (assumed to be δₜ that is approximately equal to several basic cycles of the grid and generally related to an energization speed), at t=T_{CV}+δₜ, closed-loop control over CVₜ is enabled. Thus, an inrush current generated at the moment when the closed-loop control over CVₜ is enabled is avoided.

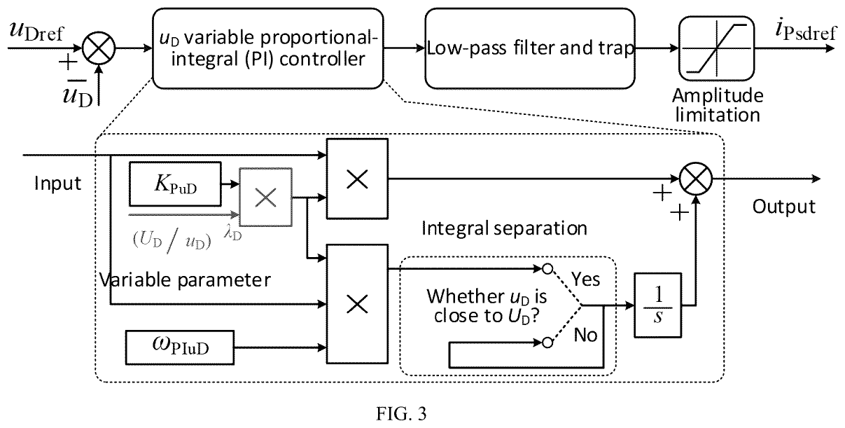

With reference to FIGS. 3, 4, 5, and 6, a control device corresponding to the system includes a grid-side current controller, a DC-link voltage controller, a split-capacitor voltage balance controller, and a load voltage controller. A d-axis reference signal of a grid-side current PI control system serves as output of the DC-link voltage controller. A zero-axis reference signal of the grid-side current PI control system serves as output of the split-capacitor voltage balance controller. A rated voltage of the DC-link voltage controller serves as a reference signal of the DC-link voltage controller. A rated load peak voltage serves as a d-axis reference signal of the load voltage controller.

Reference can be made to FIGS. 3-6 for block diagrams of improved closed-loop control over CVₚ and CVₜ involved. K_{PuD}, K_{PuDδ}, K_{Pp}, and K_{Pt} denote proportional coefficients of PI controllers of a DC-link voltage controller, a split-capacitor voltage balance controller, a grid-side current controller, and a load voltage controller respectively, and ω_{PIuD}, ω_{PIuDδ}, ω_{PIp}, and ω_{PIt} denote corner frequencies of the PI controllers respectively. In the figures, u_{Dref} denotes reference input of u_{D}; i_{Psdref}; i_{Psqref}, and i_{Ps0ref} denote reference inputs of i_{Psd}, i_{Psq}, and i_{Ps0} respectively; i_{Psd}, i_{Psq}, and i_{Ps0} denote mapping quantities corresponding to the d-axis, q-axis, and zero-axis of a synchronous coordinate system after coordinate transformation of grid-side currents i_{Psa}, i_{Psb}, and i_{Psc} respectively; u_{2dref}, u_{2qref}, and u_{20ref} denote reference input of u_{2d}, u_{2q}, and u₂₀ respectively; and u_{2d}, u_{2q}, and u₂₀ denote mapping quantities corresponding to the d-axis, q-axis, and zero-axis of the synchronous coordinate system after coordinate transformation of grid-side currents u₂ₐ, u_{2b}, and u_{2c} respectively.

At the PWM rectification stage, for the block diagram of control of the improved DC-link voltage controller shown in FIG. 3, first, u_{Dref}=U_{D} is set. Then, a real-time value of u_{D} is fed back, and an operation is performed on a deviation through a u_{D} variable PI controller, a low-pass filter, and the trap. Finally, a reference instruction i_{Psdref} of a grid-side current inner loop is acquired through an amplitude limitation link. Considering a big gap between u_{D} and u_{Dref} at the PWM rectification stage, three improved links involving the variable parameter and the integral separation are added to the u_{D} variable PI controller to avoid overshoot. According to the integral separation link involved, an integral coefficient maintains zero all the time until u_{D} exceeds U_{D}, so that integral output maintains zero output. The integral coefficient is added in a case where u_{D} exceeds U_{D} for the first time. The variable parameter link involved is to multiply K_{PuD} by (U_{D}/u_{D})^{λD}, and λ_{D} is set as −1, so that the influence of a change of u_{D} on control performance can be offset. The amplitude limitation link involved is to maintain a small threshold before the end of the PWM rectification stage. Thus, a small reference value can be output to decrease the inrush current generated at the initial phase of energization.

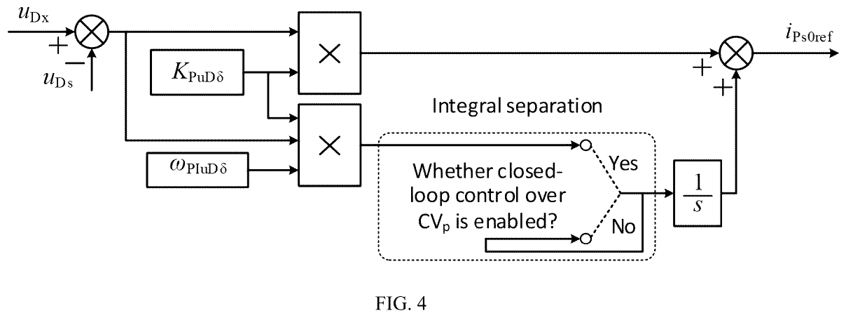

For the block diagram of control of the split-capacitor voltage balance controller shown in FIG. 4, at the PWM rectification stage, a value of u_{Dx}−u_{Ds} is taken as input of the PI controller. To avoid overshoot, an integral separation link is added. Thus, an integral part does not generate a control effect before CVₚ is enabled, and an integral does not start to generate integral output from a current value until CVₚ is enabled.

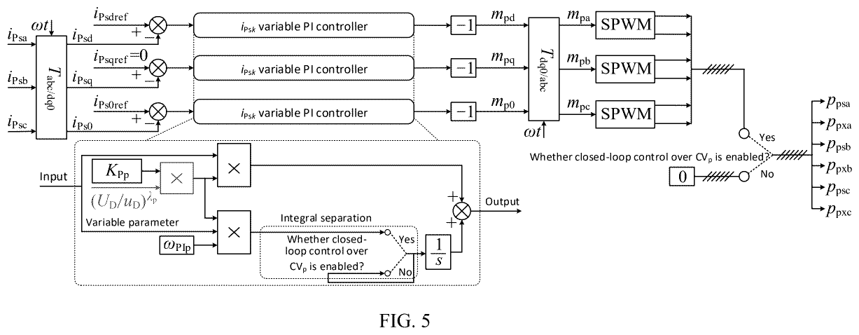

For the block diagram of control of the improved grid-side current controller shown in FIG. 5, at the PWM rectification stage, T_{abc/dq0} and T_{dq0/abc} denote a matrix configured for coordinate transformation and a matrix configured for inverse coordinate transformation respectively. A drive signal of each IGBT of CVₚ is maintained in a locked state before the closed-loop control over CVₚ is enabled. After the closed-loop control over CVₚ is enabled, i_{Psk} is fed back in real time; i_{Psd}, i_{Psq}, and i_{Ps0} are obtained through a coordinate transformation matrix operation; modulation signals m_{pd}, m_{pq}, and mₚ₀ are generated through an i_{Psk} variable PI controller in combination with the reference input i_{Psdref}, i_{Psqref}, and i_{Ps0ref}; and a drive pulse signal of each IGBT is acquired through sinusoidal pulse width modulation (SPWM) after the inverse coordinate transformation. To reduce the inrush current at the initial phase of energization, an improved variable parameter link and an improved integral separation link are added to the i_{Psk} variable PI controller. The variable parameter link involved is to multiply K_{P}_{ₚ} by (U_{D}/u_{D})^{λp}, and λₚ is set as 3-4. Thus, at the initial phase of energization, since up is less than U_{D}, a great open-loop gain is obtained, tracking performance of CVₚ is further improved, and the inrush current generated at the initial phase of energization of the PWM rectification stage is decreased. The integral separation link involved is to maintain that the integral part does not generate a control effect before CVₚ is enabled, and the integral does not start to generate integral output from a current value until CVₚ is enabled.

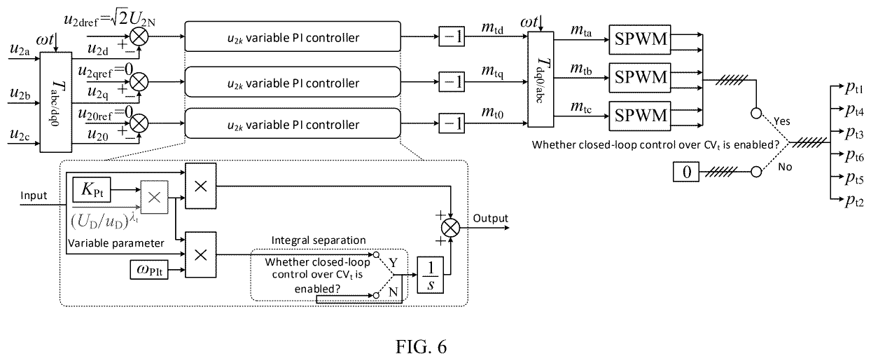

At the PWM rectification stage, for the block diagram of control of the load voltage controller shown in FIG. 6. T_{abc/dq0} and T_{dq0/abc} denote a matrix configured for coordinate transformation and a matrix configured for inverse coordinate transformation respectively. As can be seen from FIG. 2, the closed-loop control over CVₜ is enabled with a delay δₜ after the closed-loop control over CVₚ is enabled. Similar with the improved closed-loop control over CVₚ, a drive signal of each IGBT of CVₜ is maintained in a locked state before the closed-loop control over CVₜ is enabled. After the closed-loop control over CVₜ is enabled, u₂ₖ is fed back in real time: u_{2d}, u_{2q}, and u₂₀ are obtained through a coordinate transformation matrix operation; modulation signals m_{td}, m_{tq}, and mₜ₀ are generated through a u₂ₖ variable PI controller in combination with the reference input u_{2dref}, u_{2qref}, and u_{20ref}; and each drive pulse signal is acquired through SPWM after the inverse coordinate transformation is performed on the modulation signals. To improve control performance, the improved variable parameter link and the improved integral separation link are added to the u₂ₖ variable PI controller; the variable parameter link involved is to multiply K_{Pt} by (U_{D}/u_{D})^{λt}, and λₜ is set as 1, so that the influence of a change of up on load voltage control can be offset. The integral separation link involved is to maintain that the integral part does not generate a control effect before CVₜ is enabled, and the integral does not start to generate integral output from a current value until CVₜ is enabled.

What is described above is merely a preferred example of the present disclosure, and is not intended to limit the present disclosure. Any modifications, equivalent replacements, improvements, etc. made within the spirit and principles of the present disclosure should fall within the scope of protection of the present disclosure.

What is claimed is:

1. A soft-start method of a hybrid distribution transformer (HDT) based on unbypassing its voltage-compensating converter, comprising an uncontrolled rectification stage and a PWM rectification stage; wherein
the uncontrolled rectification stage comprises:
S101, opening an anti-parallel thyristor on a voltage-compensating converter bypass and a contactor on a bypass of a DC-link damping resistor, and closing a circuit breaker of the HDT;
S102, energizing a power supply module of a control circuit and a detection circuit of the HDT in a case where a DC-link voltage exceeds a threshold; and
S103, closing the contactor on the bypass of the DC-link damping resistor after set delay time in a case where the control circuit of the HDT is stabilized; and
the PWM rectification stage comprises:
S201, starting a current-compensating converter, and performing closed-loop control; and
S202, starting the voltage-compensating converter after the current-compensating converter is started and a DC-link voltage rises beyond an uncontrolled rectification steady-state value.

2. The soft-start method of an HDT based on unbypassing its voltage-compensating converter according to claim 1, wherein in S101, an isolation transformer maintains a fixed voltage ratio with a main transformer, and the voltage-compensating converter and a current-compensating converter charge a DC-link capacitor simultaneously.

3. The soft-start method of an HDT based on unbypassing its voltage-compensating converter according to claim 1, wherein in S103, the detection circuit sends out a contactor closing signal after the set delay time, and the contactor on the bypass of the DC-link damping resistor is closed.

4. A soft-start device of an HDT based on unbypassing its voltage-compensating converter, configured to implement the soft-start method based on unbypassing according to claim 1, comprising:
a grid-side current controller configured to control a current-compensating converter; cause each insulated gate bipolar transistor (IGBT) in the current-compensating converter to be in a locked state before closed-loop control over the current-compensating converter; and acquire a drive pulse signal of each IGBT after the current-compensating converter is enabled;
a DC-link voltage controller configured to acquire a deviation by comparing a real-time value and a reference value of a DC-link voltage; perform an operation on the deviation through a proportional-integral (PI) controller, a low-pass filter, and a trap; and acquire a reference instruction of a grid-side current inner loop;
a split-capacitor voltage balance controller configured to acquire a difference by comparing voltages of two DC-link capacitors; take the difference as a zero-axis reference signal of a load in a case where the current-compensating converter is not enabled; and take the difference subjected to integral separation as a zero-axis reference signal of a load in a case where the current-compensating converter is enabled; and
a load voltage controller configured to control the voltage-compensating converter; cause each IGBT in the voltage-compensating converter to be in a locked state before closed-loop control; and acquire a drive pulse signal of each IGBT after the voltage-compensating converter is enabled.

5. The soft-start device of an HDT based on unbypassing its voltage-compensating converter according to claim 4, wherein a small amplitude limitation threshold is applied to the DC-link voltage controller in a case where the DC-link voltage does not exceed a rated value; and a normal amplitude limitation threshold corresponding to a grid-side rated current is applied to the DC-link voltage controller in a case where the DC-link voltage exceeds a rated value; wherein
the small amplitude limitation threshold is 20%-30% of the grid-side rated current.

6. The soft-start device of an HDT based on unbypassing its voltage-compensating converter according to claim 4, wherein a PI parameter of the grid-side current controller, a PI parameter of the DC-link voltage controller, a PI parameter of the split-capacitor voltage balance controller, and a PI parameter of the load voltage controller are regulated through corresponding dynamic gain coefficients.

7. The soft-start device of an HDT based on unbypassing its voltage-compensating converter according to claim 4, wherein the DC-link voltage controller, the split-capacitor voltage balance controller, and the grid-side current controller are started simultaneously in a case where the closed-loop control over a current-compensating converter is started; and a variable parameter link and an integral separation link are set in a PI controller of the DC-link voltage controller.

8. The soft-start device of an HDT based on unbypassing its voltage-compensating converter according to claim 4, wherein in the grid-side current controller, i_{Psd}, i_{Psq}, and i_{Ps0} are acquired through real-time i_{Psk} in a case where the current-compensating converter is enabled; and modulation signals m_{pd}, m_{pq}, and mₚ₀ are generated through an i_{Psk} variable PI controller, and each drive pulse signal is acquired through sinusoidal pulse width modulation (SPWM); and
in the load voltage controller, u_{2d}, u_{2q}, and u₂₀ are acquired through real-time u₂ₖ in a case where the voltage-compensating converter is enabled; and modulation signals m_{td}, m_{tq}, and mₜ₀ are generated through a u₂ₖ variable PI controller, and each drive pulse signal is acquired through SPWM.

9. The soft-start device of an HDT based on unbypassing its voltage-compensating converter according to claim 8, wherein a variable parameter link and an integral separation link are set in each of the i_{Psk} variable PI controller of the grid-side current controller and the u₂ₖ variable PI controller of the load voltage controller.

10. A soft-start system based on unbypassing a voltage-compensating converter, configured to implement the soft start method based on unbypassing according to claim 1, comprising a main transformer, an isolation transformer, a current-compensating converter, and a voltage-compensating converter; wherein the main transformer is connected to the isolation transformer in series;
a primary side of the main transformer is in delta connection to a grid through a circuit breaker, and a secondary side of the main transformer is in star connection to a load through a circuit breaker;
the current-compensating converter is connected to an auxiliary winding of the main transformer in parallel, and the voltage-compensating converter is connected to a primary winding in series through the isolation transformer; and
the current-compensating converter and the voltage-compensating converter share a DC-link capacitor, the DC-link capacitor comprises two capacitors connected in series, each capacitor is connected to one damping resistor, each damping resistor is provided with one bypass, and each bypass is provided with one bypass contactor.
